(19) United States
(12) Patent Application Publication
(10) Pub. No.: US 2005/0204380 A1
(43) Pub. Date: Sep. 15, 2005

(54) Apparatus and method for transmitting and receiving broadcasting information based on program rating

(75) Inventor: Jae Kyung Lee, Kyungsangbook-Do (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/075,961

(22) Filed: Mar. 10, 2005

(30) Foreign Application Priority Data
Mar. 11, 2004 (KR) 10-2004-0016393

(51) Int. Cl. H04N 7/16

(52) U.S. Cl. 725/25; 725/28

(57) ABSTRACT

An apparatus (transceiver) and method for transmitting and receiving broadcast information based on rating are provided. The transmitter of the transceiver includes a producing part and a transmitter controller. The producing part produces at least two different versions of at least a portion of a program, the two different versions having different program ratings. The transmitter controller transmits the produced versions to a receiver of the transceiver. The receiver includes a receiver controller receiving the versions transmitted from the transmitter controller, selecting one of the received versions based on rating information, and presenting the selected version.

This application claims the benefit of Korean Patent Application No. 10-2004-0016393 filed on Mar. 11, 2004, which is hereby incorporated by reference.

### BACKGROUND OF THE INVENTION

1. Field of the Invention

The present invention relates to an apparatus and method for transmitting and receiving broadcast information including video signals, audio signals and data based on program rating.

2. Description of the Related Art

A television is a video and audio media with which modern people are most easily in contact, and it televises a variety of program genres for each age group, e.g., adult, young people, and children, or male and female. Then, since a broadcast program includes video signals, audio signals and data having suggestiveness, violence, strong coarse language and the like, which have a bad influence on the emotions of youth or children, it is strongly required to restrict a watchable program based on age.

In the case of Republic of Korea, since the broadcast programs are transmitted carrying broadcast information including mixed program IDs, the audience can recognize that the current broadcasting program is for which age group.

Also, in the case of the United States of America, as one way to solve the violence problems of youth, the Federal Communications Committee (FCC) has adopted rules requiring all television sets sold in the U.S.A. to be equipped with a mechanism to block the display of television programming based upon its rating. This technology is known as the “V-Chip.” Pursuant to the Commission's rules, half of all new television models 13 inches or larger that are manufactured after Jul. 1, 1999, and all TV sets 13 inches or larger that are manufactured after Jan. 1, 2000 must have the V-Chip technology. One example of such TV ratings is shown in Tables 1 and 2 below.

TABLE 1

| | | Ratings by Motion Picture | |
|---|---|---|---|
| TV parental guidelines | | Association of America (“MPAA”) | |
| TV-Y | All Children | G | General audience: suitable for |
| | | | all ages |
| TV-Y7 | Directed to older children | PG | Parental Guidance Suggested: |
| | | | unsuitable for younger |
| | | | children. |
| TV-G | General Audience: | PG- | Parents Strongly Cautioned: |
| | suitable for all ages | 13 | unsuitable for children under |
| | | | 13 years of age. |
| TV-PG | Parental Guidance | R | Suitable for people under 17 |
| | Suggested: unsuitable | | years only if a parent or |
| | for younger children. | | guardian is with them |
| TV-14 | Parents Strongly | NC- | Unsuitable for children under |
| | Cautioned: unsuitable | 17 | 17 years of age |
| | for children under | | |
| | 14 years of age. | | |
| TV-MA | Mature Audience | X | Mature Audience Only |
| | Only: suitable for adult | | |
| | age 17 and | | |
| | above | | |

TABLE 2
Definition based on TV parental guidelines

| | TV-Y | TV-Y7 | TV-G | TV-PG | TV-14 | TV-MA |
|---|---|---|---|---|---|---|
| Suggestive | | | | Weak | Strong | Hardcore |
| scene | | | | | | |
| Adult | | | | | Strong | |
| language | | | | | | |
| Violence | | Fantasy | | Normal | Strong | Graphic |
| Suggestive | | | | Weak | Strong | Hardcore |
| dialogue | | | | | | |

Thus, the V-CHIP rating system help control program viewing based on the ratings as regulated in Tables 1 and 2.

In Table 2, blank cells represents that it is impossible to view a corresponding scene and marked cells represents that it is possible to view the corresponding scene, which are examples.

Accordingly, each of the broadcasting companies and video manufacturers is required to carry information related with the program rating on 21-th line of a vertical blanking signal, and to perform picture blocking, audio muting and deletion of caption letter that is data when a rating violation signal is inputted. The program rating given by the broadcasting company is referred to as a provider input rating.

FIG. 1 is a flowchart illustrating a rating control of a related art digital television.

Referring to FIG. 1, a microcomputer (micom) of a television (TV) periodically checks whether an audience (or user) has set a user input rating. (S101) For example, a parent may set a rating of “TV-G” for any viewing of TV programs by his children.

When the user input rating has not been set, the microcomputer allows the transmitted broadcast program, for example, video and audio signals, to be outputted through a display and a speaker without any restriction. But if the user input rating has been set, the microcomputer determines the program rating of the input broadcasting program. (S102) In the above operations, the provider's rating setting is carried on each broadcasting program as the broadcast information.

Next, the microcomputer checks the provider input rating of a corresponding broadcasting program and determines whether the provider input rating is higher than the user input rating set by the user. A provider input rating is a rating given to a program by the provider of the program such as the network station providing the program.

At this time, when it is determined that the provider input rating is higher than the user input rating, the program viewing should be and is blocked, e.g., pictures and audio are blanked. (S104) However, if the provider input rating is lower than the user input rating, the program viewing is possible and the pictures and audio of the program are outputted without any blanking. (S105)

In the above, the rating is generally set to be higher as the number of restriction elements increases, and vice versa.

In the related art, a viewer either sees a particular program or a blanked program depending on the rating of the program and the rating set for the viewer. This may create a situation where the viewer is not able to see many or all broadcast programs because the programs are blocked out for that viewer.

### SUMMARY OF THE INVENTION

Accordingly, the present invention is directed to an apparatus and method for transmitting and receiving broadcast information based on program rating that substantially obviate one or more problems due to limitations and disadvantages of the related art.

An object of the present invention is to provide an apparatus and method for transmitting and receiving broadcast information based on program rating in which when a broadcast program has a rating unsuitable for children or youth, i.e., it includes an unsuitable scene (violence, suggestiveness, unsuitable language, etc.), the program provider produces at least two versions of the program with different video, audio, and data streams. For instance, pictures, videos, sounds and/or captions of at least a portion of a broadcast program are produced differently (in many versions) according to a prescribed rule (program ratings) without affecting the story line of the program. Then one of the versions that corresponds to the user input rating is selected and presented to the user. As a result, a version of the program that is most suitable for each viewer is presented to the viewer at the viewer's side.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided according to an aspect of the invention a system for presenting broadcast information based on rating, the system comprising: a transmitter including a producing part and a transmitter controller, the producing part producing at least two different versions of at least a portion of a program, the at least two different versions having different program ratings, the transmitter controller transmitting the produced versions.

According to another aspect of the invention, there is provided a receiver for presenting broadcast information based on rating, the receiver comprising: a controller to receive broadcast information from a transmitter, the broadcast information including at least two different versions of at least a portion of a program, the at least two different versions having different program ratings, the controller selecting one of the received versions based on rating information; and a presentation device to present the selected version at a user side.

According to another aspect of the invention, there is provided a method for presenting broadcast information based on rating, the method comprising: producing, at a transmitter side, at least two different versions of at least a portion of a program, the at least two different versions having different program ratings; and transmitting the produced versions.

According to another aspect of the invention, there is provided a method for presenting broadcast information based on rating, the method comprising: receiving, at a receiver side, broadcast information from a transmitter side, the broadcast information including at least two different versions of at least a portion of a program, the at least two different versions having different program ratings; selecting one of the received versions based on rating information; and presenting the selected version at a user side.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a flowchart illustrating a rating control of a related art digital television;

FIG. 2 is a block diagram of a video/audio/data signal transceiver that controls a restricted rating through a broadcast information stream configuration based on its rating according to the present invention;

FIG. 3 is a flowchart showing a restricted rating control process in the transceiver of FIG. 2 according to the present invention;

FIG. 4 is a flowchart showing an example of a restricted rating control process involved in step S303 of FIG. 3 according to an embodiment of the present invention;

FIG. 5A is a flowchart showing an example of a restricted rating control process in the transceiver of FIG. 2 and FIG. 5B is a flowchart showing another example of a restricted rating control process in the transceiver of FIG. 2 according to the present invention; and

FIGS. 6A and 6B are views showing examples of video and audio transmission streams (TP streams) based on program rating and a preferred picture according to the present invention.

### DETAILED DESCRIPTION OF THE PREFERRED EMBODIMENTS

Reference will now be made in detail to the preferred embodiments of the present invention, examples of which are illustrated in the accompanying drawings.

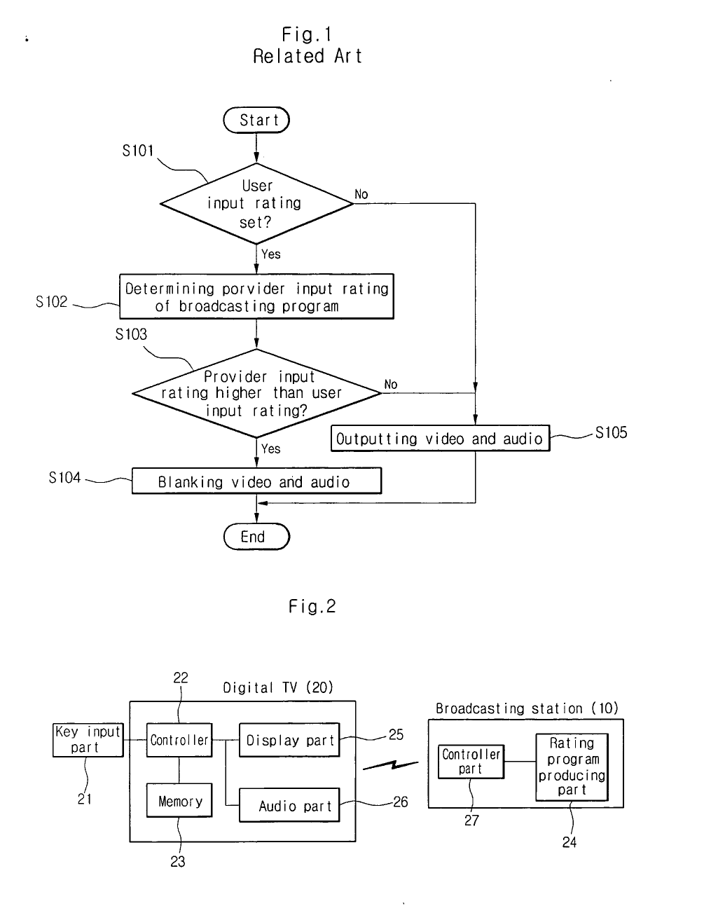

In the related art of FIG. 1, a ‘broadcast program’ includes video, audio and data, where this data is referred to as ‘broadcast information’. However, in the present invention, ‘broadcast information’ includes video, audio and data and is not restricted to only the data. For instance, different versions of a program are referred to as broadcast information, which includes video, audio and data (e.g., rating information) associated with that version. In this regard, broadcast information and broadcast program may be used interchangeably.

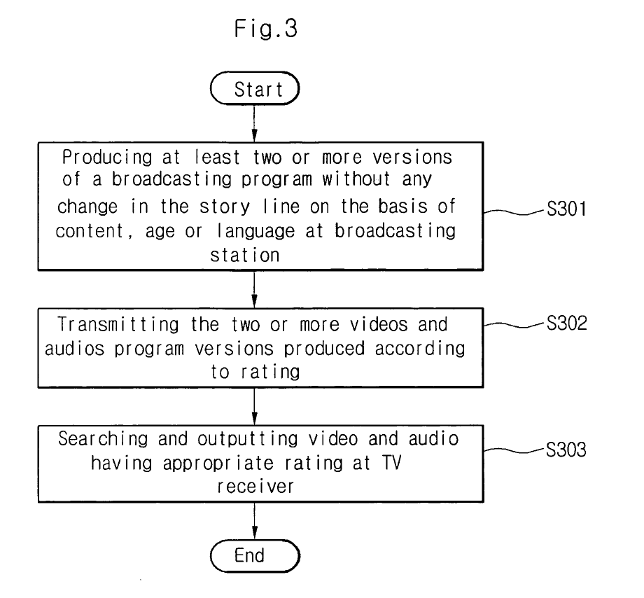

FIG. 2 is a block diagram of a video/audio/data signal transceiver that controls presentation of programs through a broadcast information stream configuration based on program ratings according to the present invention.

Referring to FIG. 2, an apparatus (transceiver) for transmitting and receiving broadcast signals, for example, video/audio/data, according to an embodiment of the present invention produces at least two different versions of a broadcast program without changing the story line of the program when the broadcast program includes violence, suggestiveness and/or unsuitable language (strong and coarse words, abuse and provincial accent).

More specifically, the transceiver includes a transmitter for transmitting broadcast information including plural video signals and plural audio signals which are produced into multiple versions having different ratings, and a receiver for searching for the video and audio signals (a particular version) having the rating below a user input rating set by a user among the plural versions of the program having the different ratings that are transmitted from the transmitter, for example, among video and audio signals and data.

In the example of FIG. 2, the transmitter corresponds to a broadcasting station 10, which produces and televises the broadcast programs, and the receiver corresponds to a digital television (TV) 20, which controls the rating through video, audio and data stream configuration. The broadcasting station 10 includes a station controller 27 and a rating program producing part 24, all operatively coupled.

When a particular program to be broadcast contains a certain rating signal due to, e.g., the existence of violence, suggestiveness, unsuitable words, etc., the rating program producing part 24 produces two or more versions of the program where these versions have the same story line (i.e., no change to the story line). Here in the present invention, the different versions of a program means at least a portion (e.g., a scene) of the program differs between the different versions. Each version of the program has a different program rating and scene(s) corresponding to that rating, such that the different versions have different ratings. That is, the rating program producing part 24 creates the versions of the program to correspond to a list of different program ratings such as for different age groups as in Table 1. Each version of the program can be carried in a separate video and audio stream. Although audio and video variations will be discussed, the invention is not limited to such and equally applies to caption variations according to the ratings. If the different versions of the program apply to varying the captions associated with the program, then each version of the captions may be carried in a separate data stream for carrying the caption text data.

The station controller 27 controls the transmission of the created two or more video streams and audio streams (versions) produced by the rating program producing part 24 one by one or all at once if possible over one channel. The portion of the streams carrying the different versions of the scene(s) including audio, video and data (rating information) is also referred to in the present invention as broadcast information.

The receiver, i.e., the digital TV 20, includes a key input part 21 having a variety of function keys for inputting a user input rating set by a user, a controller 22 for controlling the respective elements of the digital TV 20 in response to a signal transmitted by the key input part 21 and also controlling to search and output the video and audio signals having the provider input rating that matches with the user input rating when the transmitter 10 transmits two or more video and audio signals carrying different versions of the broadcast program having the same story line, a memory 23 for temporarily storing the two or more video and audio signals under control of the controller 22, a display part 25 for displaying the video of the program under control of the controller 22, and an audio part 26 for outputting the audio of the program under control of the controller 22. All the components of the transceiver are operatively coupled.

That is, according to the present invention, the receiver receives two or more different versions of a program, each version having a different program rating (and the scene(s) corresponding to that rating). If a particular rating has been set for a current viewer, then the receiver searches the different versions of the program and selects and displays a particular version that has the rating corresponding to (or appropriate for) the rating set for the viewer. In this way, the program is not blocked out for the viewer and the viewer is still able to view the program by viewing the version that is most suitable for the viewer, e.g., for his age, maturity, etc.

In the present invention, the plural versions of the digital TV broadcasting program may be transmitted one by one or all at once over one channel.

Accordingly, a TV outputting a high definition (HD) broadcasting program uses a packet identifier (PID) contained in a head of a format of the transmitted video signal so as to separate the plurality of versions. The receiver can access each version of the program selectively using the PID.

Also, a TV outputting a standard definition (SD) broadcasting program includes two or more data representing the rating in one channel, the two or more data including a rating video packet Identifier (PID), an audio PID, or a PID considering video and audio overall.

In particular, the receiver may assign different numbers to the PIDs so as to discriminate the video and audio signals from each other and also discriminate the ratings assigned to the video and audio signals.

By the above construction, although a broadcast program has the restriction rating due to the use of suggestive, violent or unsuitable languages, all family members can still view the corresponding program without a large change in the story line unlike the related art.

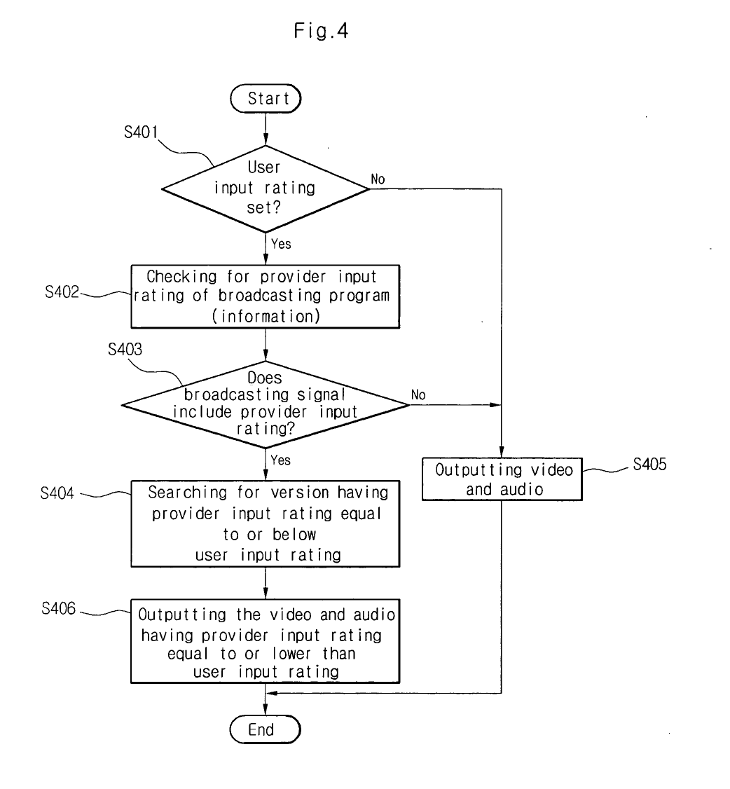

FIG. 3 is a flowchart schematically showing a restricted rating control process in the transceiver of FIG. 2 according to an embodiment of the present invention. However, this process may be implemented in other suitable device or system.

Referring to FIG. 3, first, when the broadcasting station determines that a rating (e.g., based on Table 1) should be added to a broadcast information due to the use of suggestive, violent or unsuitable languages or the like, the broadcasting station produces two or more versions of the broadcast program that have different ratings without any change in the story or story line of the program. (S301) The ratings given to these versions of the broadcast program by the broadcasting station are referred to as provider input ratings. Thereafter, the broadcasting station transmits video and audio signals carrying these versions of the broadcast program, i.e., carrying the broadcast information. (S302)

Then, the digital TV receiver receives the transmitted video and audio signals. The digital TV receiver determines whether or not a user/viewer has set a restriction rating. The user-set rating is referred to as a user input rating. If it is determined that there exists the user input rating (e.g., for the transmitted signals/program, for the broadcasting time of the program, for the current viewer, etc.), the digital TV receiver searches the received video and audio signals to locate a video and audio signal (version of the program) having the provider input rating equal to or lower than the user input rating. Then the receiver presents the located video and audio signal to the current viewer. (S303)

Next, a method for configuring the broadcast program to provide different versions thereof based on program ratings will now be described according to the present invention.

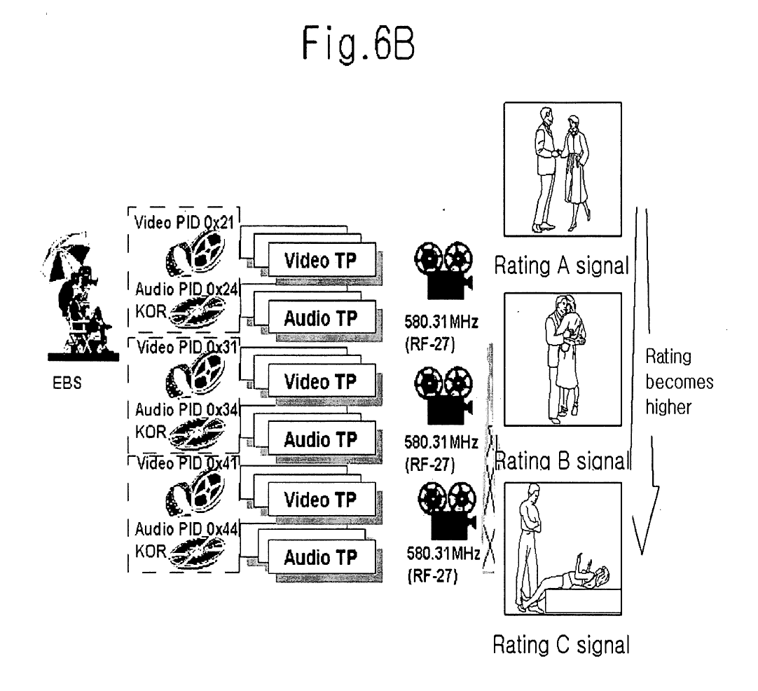

For example, as shown in FIG. 6B, when a rating is required for a love scene of a couple in a program, a hand-holding scene (rating A) is produced as the broadcast information for viewing by primary school students or below, a kiss scene (rating B) is produced as the broadcasting information for viewing by middle and high school students, and a sexual scene (rating C) is produced as the broadcasting information for viewing by collegiate and university students. That is, three different versions of the program are produced without affecting the story line. In addition, audios and/or captions respectively matched with the produced videos are produced without changing the whole story and to correspond to the assigned ratings.

In the example of FIG. 6B, when the three versions of the scene in the program are transmitted and the digital TV receiver has the rating set for the current user/viewer, the digital TV receiver selects one of the three versions by comparing the ratings of these versions with the current user's set rating, and thereby outputs the version of the broadcast program that is most suitable for the current user in terms of ratings.

If the user input rating for the digital TV or the current viewer has not been set, then one of the versions of the program can be presented to the current viewer as a default mode display. For the default mode display, the broadcast station/provider can designate in advance which version of the program is to be presented in the default mode. For instance, the scene that was originally created by the producer of the movie may be designated as the default mode display version.

In the above operation, if it is determined that the number of the program versions satisfying the restriction rating set by the user is two or more, the program version having a relatively higher rating or highest or lowest rating among the satisfying versions may be displayed. This can be set up by a user or system operator as desired.

That is, if the program transmitted by the broadcasting station has a signal containing the rating, the digital TV receiver may search and output the video and audio signals having the provider input rating that is equal to (if no, lower than) the user input rating, whereas if the transmitted program does not have a signal containing the rating, the digital TV receiver outputs the video and audio signal designated for the default mode display.

In the above operation, it is allowed to display the video and audio signals having a higher provider input rating, but it substantially depends on the rating setting by the provider.

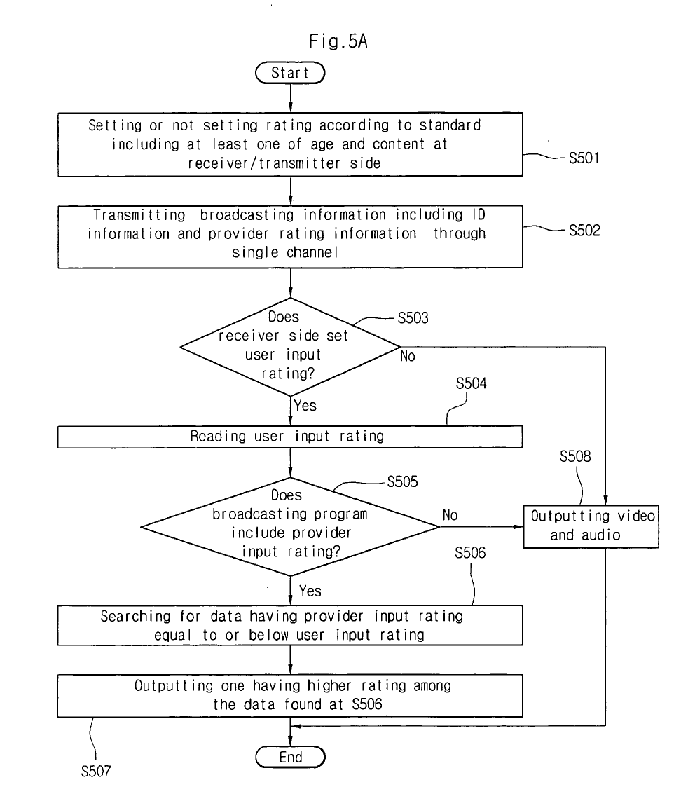

FIG. 4 is a flowchart showing a restricted rating control process involved in step S303 of FIG. 3 according to the present invention. This process is implemented in the transceiver of FIG. 2, but can be implemented in other suitable device or system.

Referring to FIG. 4, the controller 22 of the digital TV periodically checks whether an audience (or user) has set a program rating. (S401)

Alternatively, before the user sets the rating, a user recognition step of recognizing the user using an identification (ID), a password, a fingerprint recognition, an iris recognition and the like may be further included.

If it is determined that the user input rating has not been set, the controller allows the transmitted broadcast information, for example, video and audio signals, to be outputted through a display and a speaker without any change. That is, if there are no multiple versions of the program, then the transmitted program is presented. If there are multiple versions of the program, then the version designated for a default mode is presented. (S405)

On the other hand, if it is determined that the user input rating has been set, the controller checks for a broadcast program input rating (provider input rating) of the transmitted broadcast program. (S402)

In the above operations, the provider input rating represents a signal carried on a broadcast program by the broadcasting station so as to display the program (version thereof) most suitable for a subject audience in OSD. The broadcast information input rating is used as having the same meaning as the provider input rating.

In the above operation, the provider input rating may be set independently considering video or used language, or considering both the video and used language, or based on viewer age or content.

Next, if the broadcast signal includes at least one provider input rating (step S403), the controller of the digital TV determines whether or not the current program includes a signal unsuitable for the user input rating by examining the provider input rating(s). For instance, when the user sets the user input rating to be suitable for age 12 or below, the controller determines whether or not the current program includes a scene unsuitable for the audience of age 12 or below. If it is determined that the current program includes a scene unsuitable for the audience of age 12 or below, the controller searches the two or more video and audio streams (versions of the program) and outputs the broadcast information having the provider input rating that matches (if not, lower than) the user input rating. This is accomplished by comparing the user input rating with the provider input ratings assigned to the different versions of the program portion. (S404 and S406)

However, if it is determined that the current program does not include a scene unsuitable for the audience of age 12 or below, or if it is determined that the broadcast signal does not include the provider input rating, the controller determines that the current broadcast program is one having the rating that is lower than the user input rating, i.e., it is suitable for all audiences. Thus, the controller outputs the current broadcast program without any change. That is, step S405 discussed above is performed.

Thus, according to the present invention, when it is required to add a rating to a broadcasting program, the broadcasting station produces two or more versions of the broadcast program corresponding to an issued scene which may have violence, suggestiveness, sexual content, inappropriate language and the like, and outputs two or more videos and audios corresponding to these versions of the scene and audio having the same story line. The digital TV receiver then receives these versions of the program and selects the version (video and audio) having the rating that matches with the user input rating. This allows the audience to watch a program, which was not allowed in the related art TV receiver having the rating function.

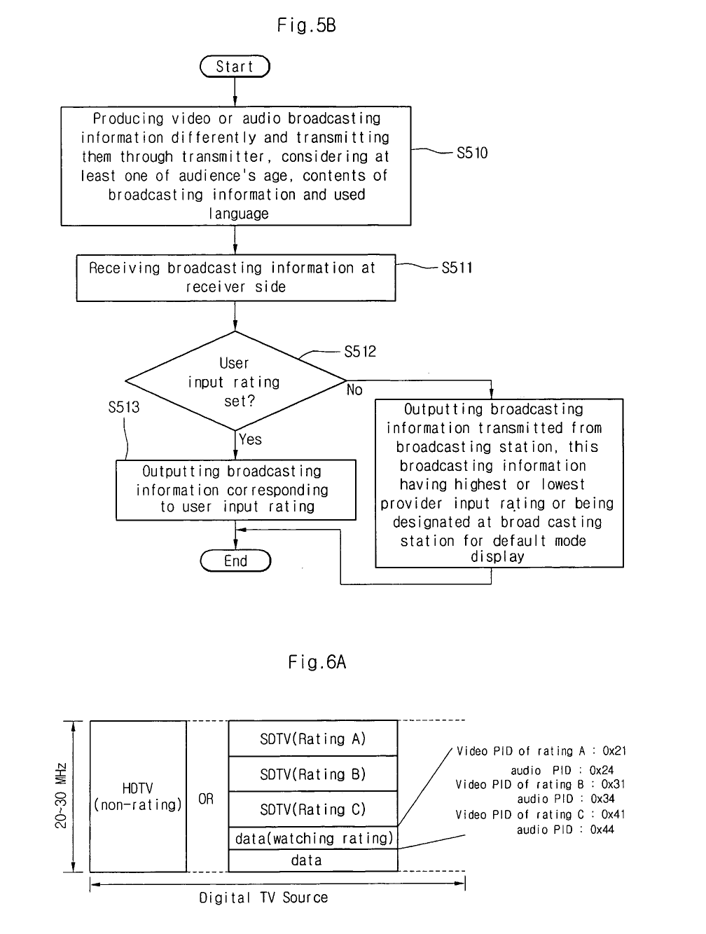

FIG. 5A is a flowchart showing an example of a restricted rating control process in the transceiver of FIG. 2 and FIG. 5B is a flowchart showing another example of a restricted rating control process in the transceiver of FIG. 2. These processes can be implemented in other suitable device or system.

Referring to FIG. 5A, at the transmitter side, the rating (provider input rating) of a program or program portion can be set or not set based on the audience's age, the used language and/or the contents. Similarly, at the receiver side, the rating (user input rating) can be set or not set based on the audience's age, the used language and/or the contents. (S501) For instance, as many different programs are carried in a channel, the broadcasting station can selectively choose to set the provider rating for only certain programs among all the programs carried in the channel. Similarly, at the receiver side, the user can configure the receiver to apply the user input rating at certain times.

Then the transmitter transmits the provider set rating information (e.g., PIDs for different video/audio signals having different ratings as shown in FIGS. 6A and 6B) over one channel. (S502)

The receiver determines whether or not the user input rating is set. (S503) If the user input rating is not set, the broadcast information having the highest provider input rating among the transmitted versions is displayed. However, the present invention is not limited to this configuration and can have other variations such as displaying the version having the lowest provider input rating.

Meanwhile, when the user input rating is set at the receiver side, the user input rating is read. It is then determined whether or not the broadcast information corresponding to the user input rating exists, and then the broadcast information having the rating equal to the user input rating is searched. (S505, S506) If there is no broadcast information having the rating equal to the user input rating, then the broadcast information having the rating that is most close to, but not exceeding, the user input rating is searched.

Once the broadcast information corresponding to the user input rating is located, it is output to the user. If there are more than one broadcast information that satisfies the user input rating, then the broadcast information having the highest rating (or lowest rating if desired) is outputted. This can be selected by the user at the receiver side. In the alternative, the provider can designate which version of the program should be displayed if there is no user input rating set. (S507)

FIG. 5B is a flowchart showing another example of a restricted rating control process in the transceiver of FIG. 2. This process can be implemented in other suitable device or system.

Considering at least one of the audience's age, contents of the broadcasting information and the use language, a specific video or audio broadcast information is produced differently and transmitted through the transmitter. (S510) In this example, all programs carried in a channel have been assigned with the provider's ratings. Also, only the video or only the audio may have different versions according to the ratings, in this example.

The receiver receives the transmitted broadcast information. (S511) Then it is determined whether or not the user input rating is set. (S512) If the user input rating is set, the broadcast information corresponding to the user input rating is outputted as discussed above. (S513) On the contrary, if the user input rating is not set, the broadcast information transmitted from the broadcasting station is outputted. (S514) At this point, the version of the program having the highest or lowest provider input rating may be presented, which can be set by the user at the receiver side. In the alternative, the version of the program designated by the provider for the default mode display may be presented as discussed above.

FIGS. 6A and 6B are views illustrating video and audio transport stream transmissions and scenes having different ratings according to an example of the present invention.

As shown in FIG. 6A, a digital TV has an advantage of being flexibility and can provide high-quality non-rating HD and multi-channel SD by using the data compression technology. In one channel, many programs can be carried, where one or more of these programs have different versions with different ratings, and the rest of the programs have a single version having only one rating. Here, the digital TV broadcasting can transmit one or more images of one channel and also transmit a plurality of images within an allowable range of transmission rate at a time. In addition, the digital TV broadcasting contains a packet identifier (PID) at the head of an image so as to discriminate a plurality of transmitted images. The TV that broadcasts an SD broadcasting program includes a plurality of data representing the rating within one channel, and the data include a video PID and an audio PID based on the ratings. Also, the digital TV can provide various supplementary services through data transmission, in addition to TV signals.

As shown in FIG. 6B, if the user sets the rating like an analog V-chip by using the characteristics of the described-above digital TV, the broadcasting station produces scenes (a general scene of rating A, a slight suggestive scene of rating B, and a suggestive scene of rating C) according to the rating, based on the corresponding portions (violence, suggestiveness, use language, etc.), and creates audios corresponding to these scenes. Then, the broadcasting station transmits the plurality of videos and audios of these scenes. The TV receiver searches the received plurality of videos and audios for a particular video and audio that matches with the user input rating and then outputs them once found.

In the example as shown in FIG. 6B, a TV drama is rated by the provider into three ratings, that is, a rating A for the primary school students or younger, a rating B for the middle and high school students or younger, and a rating C for the adults older than college students.

Among the entire plot of the drama, in the case of the rating where a love scene is set, the corresponding scene is differently produced based on the rating, while the plot of the entire story is not changed. That is, different versions of the love scene are produced without changing the story line of the program. As shown in FIG. 6B, in the case of the rating A signal for the primary school students or younger, a scene where the lovers hold hands is produced; in the case of the rating B signal for the middle and high school students or younger, a scene where the lovers kiss each other is produced; and in the case of the rating C signal for the adults older than the college students, a scene where the lovers make love to each other is produced. The scenes whose ratings are gradually higher, like a general scene, a slight suggestive scene and a suggestive scene, are produced and then audios for the respective scenes are created. In this manner, a sequential plot is achieved.

In the digital TV receiver, PID numbers are differently constructed so as to discriminate the video and audio signals with respect to the rated video and audio signals transmitted from the broadcasting station and to discriminate the rating of the signal. Thus, as one example, the PIDs are used to identify and locate different versions of the program according to the present invention.

For example, as shown in FIG. 6A, in the case of the rating A, a video PID and an audio PID are numbered by 0×21 and 0×24, respectively. In the case of the rating B, a video PID and an audio PID are numbered by 0×31 and 0×34, respectively. In the case of the rating C, a video PID and an audio PID are numbered by 0×41 and 0×44. In FIG. 6B, “TP” represents a transport stream.

Recently, suggestive, violent or unsuitable languages are used in music videos, music broadcasting programs and CFs. Therefore, different versions of such programs can also be produced and displayed based on the ratings according to the present invention, thereby allowing the audience to watch them according to the ratings.

If suggestive or violent scenes and audios are produced based on the rating and then transmitted from the broadcasting station, the receiver outputs the video and audio that match with the user input rating. Accordingly, the audiences who are not suited to view the program having a particular rating can now watch a different version of the program having the appropriate rating and the same story line. This is not allowed under the existing TV program rating operation.

As described above, if it is required to output the different broadcast information based on the audience's age and sex, the contents or the use language, the corresponding broadcast information can be differentiated based on the rating. Thus the audience can safely watch the contents of the same story with the different broadcasting information.

According to the present invention, if a specific scene among the entire broadcast information needs to be rated, the broadcasting station can transmit a plurality of scenes produced based on the rating with respect to the corresponding information, without changing the entire plot of the story.

The digital TV receiver searches for and outputs the video and audio stream having a rating that matches the user input rating, thereby allowing any and all audiences to watch the program having the same story line and also being suitable for each audience.

In addition, the present invention can be applied to other fields, such as music videos or games, where programs must be differently outputted considering the age of the audience. The invention is also applicable to displaying programs/videos/audios in any display device such as a PDA, laptop, computer, mobile phone, etc. In such cases, the transmitter can be a broadcasting station or other source such as a website manager, ISP, etc.

It will be apparent to those skilled in the art that various modifications and variations can be made in the present invention. Thus, it is intended that the present invention covers the modifications and variations of this invention provided they come within the scope of the appended claims and their equivalents.

1. A system for presenting broadcast information based on rating, the system comprising:
a transmitter including a producing part and a transmitter controller, the producing part producing at least two different versions of at least a portion of a program, the at least two different versions having different program ratings, the transmitter controller transmitting the produced versions.

2. The system of claim 1, wherein the at least two different versions have a same story line.

3. The system of claim 1, wherein the at least two different versions have different videos, audios, and/or data.

4. The system of claim 1, further comprising:
a receiver including a receiver controller, the receiver controller receiving the versions transmitted from the transmitter controller, selecting one of the received versions based on rating information, and presenting the selected version.

5. The system of claim 4, wherein the receiver controller determines if there is a user input rating, and selects the one of the versions based on the determination result.

6. The system of claim 5, wherein if the receiver controller determines that there is a user input rating, the receiver controller compares the user input rating with the program ratings of the at least two versions, and selects one of the versions having the program rating that matches the user input rating.

7. The system of claim 5, wherein if the receiver controller determines that there is a user input rating, the receiver controller compares the user input rating with the program ratings of the at least two versions, and selects one of the versions having the program rating that is closest to the user input rating without exceeding the user input rating.

8. The system of claim 5, wherein if the receiver controller determines that there is no user input rating, the receiver controller selects one of the versions designated at the transmitter side as a default mode version, or selects a version having the highest or lowest program rating.

9. The system of claim 8, wherein the receiver controller selects the version having the highest or lowest program rating depending on a user set-up at the receiver side.

10. The system of claim 1, wherein the program ratings are assigned to the versions based on at least one of age, content and language.

11. A receiver for presenting broadcast information based on rating, the receiver comprising:
a controller to receive broadcast information from a transmitter, the broadcast information including at least two different versions of at least a portion of a program, the at least two different versions having different program ratings, the controller selecting one of the received versions based on rating information; and
a presentation device to present the selected version at a user side.

12. The receiver of claim 11, further comprising:
a user input device to receive a user input rating,
wherein the controller determines if there is a user input rating received by the user input device, and selects the one of the versions based on the determination result.

13. The receiver of claim 11, wherein if the controller determines that there is a user input rating, the controller compares the user input rating with the program ratings of the at least two versions, and selects one of the versions having the program rating that matches the user input rating.

14. The receiver of claim 11, wherein if the controller determines that there is a user input rating, the controller compares the user input rating with the program ratings of the at least two versions, and selects one of the versions having the program rating that is closest to the user input rating without exceeding the user input rating.

15. The receiver of claim 11, wherein if the controller determines that there is no user input rating, the controller selects one of the versions designated at the transmitter side as a default mode version, or selects a version having the highest or lowest program rating.

16. The receiver of claim 11, wherein the controller selects the version having the highest or lowest program rating depending on a user set-up at the receiver side.

17. The receiver of claim 11, wherein the at least two different versions have a same story line, and different videos, audios, and/or data.

18. The receiver of claim 11, wherein the program ratings are assigned to the versions based on at least one of age, content and language.

19. A method for presenting broadcast information based on rating, the method comprising:
producing, at a transmitter side, at least two different versions of at least a portion of a program, the at least two different versions having different program ratings; and
transmitting the produced versions.

20. The method of claim 19, wherein the at least two different versions have a same story line.

21. The method of claim 19, wherein the at least two different versions have different videos, audios, and/or data.

22. The method of claim 19, further comprising:
receiving, at a receiver side, the versions transmitted from the transmitter side;
selecting one of the received versions based on rating information; and
presenting the selected version.

23. The method of claim 22, wherein the selecting step includes:
determining, at the receiver side, if there is a user input rating; and
selecting the one of the versions based on the determination result.

24. The method of claim 23, wherein if it is determined that there is a user input rating, the selecting step compares the user input rating with the program ratings of the at least two versions, and selects one of the versions having the program rating that matches the user input rating.

25. The method of claim 23, wherein if it is determined that there is a user input rating, the selecting step compares the user input rating with the program ratings of the at least two versions, and selects one of the versions having the program rating that is closest to the user input rating without exceeding the user input rating.

26. The method of claim 23, wherein if it is determined that there is no user input rating, the selecting step selects one of the versions designated at the transmitter side as a default mode version, or selects a version having the highest or lowest program rating.

27. The method of claim 26, wherein if it is determined that there is no user input rating, the selecting step selects the version having the highest or lowest program rating depending on a user set-up at the receiver side.

28. The method of claim 19, wherein the producing step is performed for each of a plurality of programs to be transmitted in a channel.

29. The method of claim 19, wherein the producing step is performed for at least one of a plurality programs to be transmitted in a channel.

30. The method of claim 19, wherein the program ratings are assigned to the versions based on at least one of age, content and language.

31. A method for presenting broadcast information based on rating, the method comprising:
receiving, at a receiver side, broadcast information from a transmitter side, the broadcast information including at least two different versions of at least a portion of a program, the at least two different versions having different program ratings;
selecting one of the received versions based on rating information; and
presenting the selected version at a user side.

32. The method of claim 31, wherein the selecting step includes:
determining if there is a user input rating received at the receiver side; and
selecting the one of the versions based on the determination result.

33. The method of claim 32, wherein if it is determined that there is a user input rating, the selecting step compares the user input rating with the program ratings of the at least two versions, and selects one of the versions having the program rating that matches the user input rating.

34. The method of claim 32, wherein if it is determined that there is a user input rating, the selecting step compares the user input rating with the program ratings of the at least two versions, and selects one of the versions having the program rating that is closest to the user input rating without exceeding the user input rating.

35. The method of claim 32, wherein if it is determined that there is no user input rating, the selecting step selects one of the versions designated at the transmitter side as a default mode version, or selects a version having the highest or lowest program rating.

36. The method of claim 35, wherein the selecting step selects the version having the highest or lowest program rating depending on a user set-up at the receiver side.

37. The method of claim 31, wherein the program ratings are assigned to the versions based on at least one of age, content and language.

38. The method of claim 31, wherein the at least two different versions have a same story line, and different videos, audios, and/or data.
